(19) United States
(12) Patent Application Publication
(10) Pub. No.: US 2006/0068317 A1
(43) Pub. Date: Mar. 30, 2006

(54) Poly(arylene ether) composition

(76) Inventors: Steven R. Klei, Guilderland, NY (US); Torben P. Kempers, Bergen op Zoom (NL)

Correspondence Address: CANTOR COLBURN, LLP, 55 GRIFFIN ROAD SOUTH, BLOOMFIELD, CT, 06002, US

(21) Appl. No.: 10/955,503

(22) Filed: Sep. 30, 2004

(51) Int. Cl. G03C 1/76

(52) U.S. Cl. 430/270.1

(57) ABSTRACT

A composition comprising poly(arylene ether), poly(alkenyl aromatic) resin, bis(hydroxy benzene) diphosphate, a hindered amine light stabilizer, and an ultra-violet light absorbing compound, wherein the composition has a color shift (dE) less than 6.

### BACKGROUND OF INVENTION

The disclosure relates to poly(arylene ether) compositions. In particular, the disclosure relates to poly(arylene ether)/poly(alkenyl aromatic) blends with good color stability.

Poly(arylene ether)/poly(alkenyl aromatic) compositions have a wide range of desirable properties and are employed in a variety of uses. The range of uses can be extended when the composition includes a fire retardant. However in some cases poly(arylene ether)/poly(alkenyl aromatic) compositions can discolor over time.

There remains a need for a fire retardant poly(arylene ether)/poly(alkenyl aromatic) composition with little or no discoloration over time.

### BRIEF DESCRIPTION OF THE INVENTION

A composition comprising poly(arylene ether), poly(alkenyl aromatic) resin, bis(hydroxy benzene) diphosphate, a hindered amine light stabilizer, and an ultra-violet light absorbing compound, wherein the composition has a color shift (dE), as determined by ASTM D2244 after weathering according ASTM D4459 for 300 hours, less than 6 and a flame retardance of V1 or better when determined by UL94 at a thickness of 3 millimeters.

### DETAILED DESCRIPTION

Color stability in poly(arylene ether) compositions has long been sought. Over time a variety of light stabilizers and color stabilizers have been employed although color stability in a flame retardant poly(arylene ether) composition has remained problematic. Surprisingly it has been found that the choice of the flame retardant in combination with the choice of color stabilizers and light stabilizers has a significant effect on the color stability of a flame retardant poly(arylene ether)/poly(alkenyl aromatic) composition. Unexpectedly, compositions containing an bis(hydroxy benzene) diphosphate (as described below) show markedly more color stability than compositions containing other phosphate flame retardants such as resorcinol diphosphate.

In one embodiment a composition comprises poly(arylene ether), poly(alkenyl aromatic) resin, bis(hydroxy benzene) diphosphate, a hindered amine light stabilizer, and an ultra-violet light absorbing compound, wherein the hindered amine light stabilizer and ultra-violet light absorbing compound are present in a combined amount of 2.5 to 5 weight percent based on the total weight of the poly(arylene ether) and poly(alkenyl aromatic) resin and the composition has a color shift less than 6 and a flame retardance of V1 or better when determined by UL94 at a thickness of 3 millimeters. Color shift is determined after subjecting a sample of the composition to the weathering protocol according to ASTM D 4459. Color shift (dE) is determined based on the L*, a*, and b* values measured using a spectrophotometer in reflectance mode as described in ASTM D2244. Color shift is calculated according to the formula: dE=(dL*²+da*²+db*²)^{0.5} UL 94 is an abbreviation for the procedure of Underwriter's Laboratory Bulletin 94 entitled “Tests for Flammability of Plastic Materials, UL94”. The composition may further comprise a photobleachable dye, anti-oxidant, an epoxy compound, pigment, dye or a combination of two or more of the preceding additives.

In another embodiment, a composition comprises poly(arylene ether), poly(alkenyl aromatic) resin, bis(hydroxy benzene) diphosphate, hindered amine light stabilizer, ultra-violet light absorbing compound, and an epoxy compound. The composition can achieve a color shift (dE) of less than or equal to 5 and a flame retardance of V1 or better according to UL 94.

In another embodiment the composition comprises poly(arylene ether), poly(alkenyl aromatic) resin, bis(hydroxy benzene) diphosphate, hindered amine light stabilizer, photobleachable dye, ultra-violet light absorbing compound, anti-oxidant, and an epoxy compound.

As used herein, a “poly(arylene ether)” comprises a plurality of structural units of the formula (I): 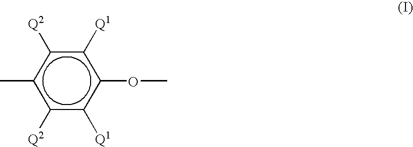
wherein for each structural unit, each Q¹ is independently hydrogen, halogen, primary or secondary lower alkyl (e.g., an alkyl containing 1 to about 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms; and each Q² is independently hydrogen, halogen, primary or secondary. lower alkyl, phenyl, haloalkyl, aminoalkyl, alkenylalkyl, alkynylalkyl, hydrocarbonoxy, halohydrocarbonoxy wherein at least two carbon atoms separate the halogen and oxygen atoms. In some embodiments, each Q¹ is independently alkyl or phenyl, for example, C₁₋₄ alkyl, and each Q² is independently hydrogen or methyl. The poly(arylene ether) may comprise molecules having aminoalkyl-containing end group(s), typically located in an ortho position to the hydroxy group. Also frequently present are 4-hydroxybiphenyl end groups, typically obtained from reaction mixtures in which a by-product diphenoquinone is present.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes polyphenylene ether containing 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The poly(arylene ether) can have a number average molecular weight of about 3,000 to about 40,000 atomic mass units (amu) and a weight average molecular weight of about 5,000 to about 80,000 amu, as determined by gel permeation chromatography. The poly(arylene ether) can have an intrinsic viscosity of about 0.10 to about 0.60 deciliters per gram (dl/g), or, more specifically, about 0.29 to about 0.48 dl/g, as measured in chloroform at 25° C. It is possible to utilize a combination of high intrinsic viscosity poly(arylene ether) and a low intrinsic viscosity poly(arylene ether). Determining an exact ratio, when two intrinsic viscosities are used, will depend somewhat on the exact intrinsic viscosities of the poly(arylene ether) used and the ultimate physical properties that are desired.

Additionally, all or part of the poly(arylene ether) may be the product of the reaction of the poly(arylene ether) and a functionalizing agent. Functionalizing agents comprise a polyfunctional compound. Polyfunctional compounds which may be employed as a functionalizing agent are of three types. The first type of polyfunctional compounds are those having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (e.g., acrylic acid, butenoic acid, methacrylic acid, t-ethylacrylic acid, pentenoic acid); decenoic acids, undecenoic acids, dodecenoic acids, linoleic acid, etc.); esters, acid amides or anhydrides of the foregoing unsaturated carboxylic acids; unsaturated alcohols (e.g. alkyl alcohol, crotyl alcohol, methyl vinyl carbinol, 4-pentene-1-ol, 1,4-hexadiene-3-ol, 3-butene-1,4-diol, 2,5-dimethyl-3-hexene-2,5-diol and alcohols of the formula CₙH₂ₙ₋₅OH, CₙH₂ₙ₋₇OH and CₙH₂ₙ₋₉OH, wherein n is a positive integer less than or equal to 30); unsaturated amines resulting from replacing from replacing the —OH group(s) of the above unsaturated alcohols with NH₂ groups; functionalized diene polymers and copolymers; and combinations comprising one or more of the foregoing. In one embodiment, the functionalizing agent comprises maleic anhydride and/or fumaric acid.

The second type of polyfunctional functionalizing agents are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and various salts thereof. Typical of this group of functionalizing agents are the aliphatic polycarboxylic acids, acid esters and acid amides represented by the formula:
(R^{I}O)ₘR(COOR^{II})ₙ(CONR^{III}R^{IV})ₛ
wherein R is a linear or branched chain, saturated aliphatic hydrocarbon having 2 to about 20, or, more specifically, 2 to about 10, carbon atoms; R^{I} is hydrogen or an alkyl, aryl, acyl, or carbonyl dioxy group having 1 to about 10, or, more specifically, 1 to about 6, or, even more specifically, 1 to about 4 carbon atoms; each R^{II} is independently hydrogen or an alkyl or aryl group having 1 to about 20, or, more specifically, 1 to about 10 carbon atoms; each R^{III} and R^{IV} are independently hydrogen or an alkyl or aryl group having 1 to about 10, or, more specifically, 1 to about 6, or, even more specifically, 1 to about 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to about 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate, mono- and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivates include the salts thereof, including the salts with amines and the alkali and alkaline metal salts. Exemplary of suitable salts include calcium malate, calcium citrate, potassium malate, and potassium citrate.

The third type of polyfunctional functionalizing agents are characterized as having in the molecule both (a) an acid halide group and (b) at least one carboxylic acid, anhydride, ester, epoxy, orthoester, or amide group, preferably a carboxylic acid or anhydride group. Examples include trimellitic anhydride acid chloride, chloroformyl succinic anhydride, chloro formyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In one embodiment, the functionalizing agent comprises trimellitic anhydride acid chloride.

The composition comprises poly(arylene ether) in an amount of 20 to 80 weight percent. Within this range, the poly(arylene ether) may be present in an amount greater than or equal to 22 weight percent, or, more specifically in an amount greater than or equal to 25 weight percent, or, even more specifically in an amount greater than or equal to 27 weight percent. Also within this range the poly(arylene ether) may be present in an amount less than or equal to 77 weight percent, or, more specifically, less than or equal to 75 weight percent, or, even more specifically, less than or equal to 73 weight percent. The weight percents are based on the total weight of the poly(arylene ether) and poly(alkenyl aromatic) resin.

The composition further comprises a poly(alkenyl aromatic) resin. The term “poly(alkenyl aromatic) resin” as used herein includes polymers prepared by methods known in the art including bulk, suspension, and emulsion polymerization, which contain at least 25% by weight of structural units derived from an alkenyl aromatic monomer of the formula 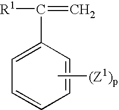
wherein R¹ is hydrogen, C₁-C₈ alkyl, or halogen; Z¹ is vinyl, halogen or C₁-C₈ alkyl; and p is 0 to 5. Exemplary alkenyl aromatic monomers include styrene, chlorostyrene, and vinyltoluene. The poly(alkenyl aromatic) resins include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ nonaromatic diene monomer, such as butadiene or isoprene, and wherein the rubber-modified poly(alkenyl aromatic) resin comprises about 98 to about 70 weight percent of the homopolymer of an alkenyl aromatic monomer and about 2 to about 30 weight percent of the rubber modifier, or, more specifically, about 88 to about 94 weight percent of the homopolymer of an alkenyl aromatic monomer and about 6 to about 12 weight percent of the rubber modifier. Rubber-modified polystyrenes are also known as high-impact polystyrenes or HIPS.

The composition comprises poly(alkenyl aromatic) resin in an amount of 20 to 80 weight percent. Within this range, the (alkenyl aromatic) resin may be present in an amount greater than or equal to 22 weight percent, or, more specifically in an amount greater than or equal to 25 weight percent, or, even more specifically in an amount greater than or equal to 27 weight percent. Also within this range the (alkenyl aromatic) resin may be present in an amount less than or equal to 77 weight percent, or, more specifically, less than or equal to 75 weight percent, or, even more specifically, less than or equal to 73 weight percent. The weight percents are based on the total weight of the poly(arylene ether) and poly(alkenyl aromatic) resin.

Bis(hydroxy benzene) diphosphate is a diphosphate compound having the formula: 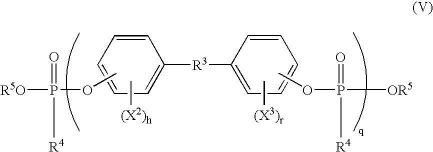
in which R³ is an alkyl having 1 to 5 carbons, each occurrence of R⁵ is, independently, an alkyl group having 1 to 8 carbons or an aryl group having 6 to 12 carbons; each occurrence of R⁴ is an alkyl, aryl, alkoxy or aryloxy having 1 to 12 carbons; X² and X³ are independently halogen or methyl; h and r are 0 or integers from 1 to 4, and q is from 1 to 10.

In one embodiment, R³ is isopropyl, R⁴ is phenoxy, R⁵ is phenyl and h and r are 0. When R³ is an isopropyl group the bis(hydroxy benzene) diphosphate may be referred to as bisphenol A diphosphate (BPADP). In an exemplary BPADP R⁴ is phenoxy, R⁵ is phenyl and h and r are 0.

The composition comprises bis(hydroxy benzene) diphosphate in an amount of 5 to 30 weight percent. Within this range, the bis(hydroxy benzene) diphosphate may be present in an amount greater than or equal to 6 weight percent, or, more specifically in an amount greater than or equal to 7 weight percent, or, even more specifically in an amount greater than or equal to 8 weight percent. Also within this range the bis(hydroxy benzene) diphosphate may be present in an amount less than or equal to 29 weight percent, or, more specifically, less than or equal to 28 weight percent, or, even more specifically, less than or equal to 27 weight percent. The weight percents are based on the total weight of the poly(arylene ether) and poly(alkenyl aromatic) resin.

As a group of functionally equivalent compounds hindered amine light stabilizers, generally referred to as HALS, are recognized by those in polymer technology as an identifiable class. The presence of the poly-substitution and/or sterically bulky group at the 2 and 6 positions of a piperidine ring is a structural characteristic of these compounds. Accordingly, the hindered amine light stabilizers comprise at least one moiety of the following structure: 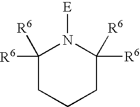
in which each R⁶ is independently an alkyl group having 1 to 8 carbons and each occurrence of E is independently an oxyl, hydroxyl, alkoxy, cycloalkoxy, arylalkoxy, aryloxy, —O—CO—OZ³, —O—Si(Z⁴)₃, —O—PO(OZ⁵S)₂, or —O—CH₂—OZ⁶ where Z³, Z⁴, Z⁵, and Z⁶ are selected from the group consisting of hydrogen, aliphatic hydrocarbons having 1-8 carbons, and aromatic hydrocarbons having 1-8 carbons. E may also be —O-T-(OH)_{b} where T is a straight or branched alkyl of 1 to 18 carbons, a cycloalkyl of 5 to 18 carbons, an alkylaryl having 7 to 14 carbons and b is 1, 2, or 3 with the proviso that b cannot exceed the number of carbon atoms in T and when b is 2 or 3, each hydroxyl is attached to a different carbon atoms of T. The hindered amine light stabilizers may be monomeric, oligomeric or polymeric.

In one embodiment, the hindered amine light stabilizers may be characterized by the formula: 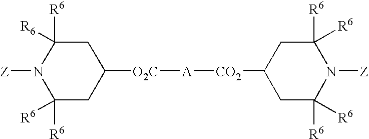
in which A is an alkanediyl i.e., a chain of methylene groups, having from 2 to 10 carbon atoms, derived from an alkane dioic acid such as succinic acid, glutaric acid, adipic acid, sebacic acid and the like. R⁶ is defined as above and each Z can be the same or different lower alkyl groups of 1 to 8 carbons or hydrogen. In some embodiments the two occurrences of R are together pentamethylene.

Exemplary hindered amine light stabilizers include, but are not limited to, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza4-oxo-spiro[4,5]decane, a reaction product of 7,7,9,9-tetramethyl-2-cycloundecyl-1-oxa-3,8-diaza-4-oxospiro [4,5]decane und epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-a-olefin-copolymer with 2,2,6,6-tetramethyl-4-aminopiperidine or 1,2,2,6,6-pentamethyl-4-aminopiperidine, 1,1′-(1,2-ethanediyl)bis(3,3,5,5-tetramethylpiperazinone), dimethyl succinate polymer with 4-hydroxy-2,2,6,6-tetramethyl-1-piperidineethanol (Ciba Geigy TINUVIN®622), and a polymeric hindered amine available from Ciba Geigy under the name CHIMASSORB®944.

The composition may comprise hindered amine light stabilizer in an amount of 0.5 to 3.0 weight percent. Within this range, the hindered amine light stabilizer may be present in an amount greater than or equal to 0.6 weight percent, or, more specifically in an amount greater than or equal to 0.7 weight percent, or, even more specifically in an amount greater than or equal to 0.8 weight percent. Also within this range the hindered amine light stabilizer may be present in an amount less than or equal to 2.9 weight percent, or, more specifically, less than or equal to 2.8 weight percent, or, even more specifically, less than or equal to 2.7 weight percent. The weight percents are based on the total weight of the poly(arylene ether) and poly(alkenyl aromatic) resin.

Ultra-violet light absorbing compounds include benzotriazole compounds and benzophenone compounds. Benzotriazoles and benzophenones may be used separately or in combination. Useful benzotriazole compounds may comprise 2-(2′-hydroxyphenyl)benzotriazoles. Exemplary benzotriazole compounds include, but are not limited to, 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro- benzotriazole, 2-(3′-sec-butyl-5′-tert-butyl-2′-hydroxyphenyl)benzotriazole, 2-(2′-hydroxy-5′-cyclohexylphenyl)-benzotriazole, 2-(2′-hydroxy-3′-methyl-5′-tert-butylphenyl)-benzotriazole, 2-(2′-hydroxy-3′,5′-dimethylphenyl)-benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-do decyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-alkylphenol], the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]₂ where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole, 2-[2′-hydroxy-3′-(1,1,3,3-tetramethylbutyl)-5′-(α,α-dimethylbenzyl)-phenyl]benzotriazole, 2-(2′-hydroxy-5′-tert-butylphenyl)-5-chloro-benzotriazole, and 2-(2′-hydroxy-3′-di-tert-butylphenyl)-benzotriazole.

The benzophenone compounds may comprise one or more hydroxyl groups substituted on one or more the aromatic rings. In one embodiment the benzophenone compounds comprise a hydroxy group in the ortho (2) position (also known as β-hydroxy substituted), together with a hydroxy, alkoxy or alkyl ether group elsewhere on the same ring, particularly in the “4”, or para, position. Typically, such compounds will be those of the formula 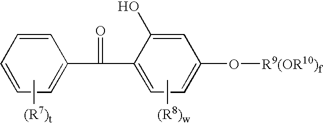
in which R⁹ is hydrogen, or a monovalent or divalent radical of a straight or branched alkane having 1 to 25 carbon atoms, substituted or unsubstituted with a hydroxyl group or groups; R¹⁰ has the same definition as R⁹ except it is always a monovalent radical, with R⁹ and R¹⁰ being the same or different in the same compound; R⁷ and R⁸ are independently hydroxy, straight or branched alkyl groups having from 1 to about 10 carbon atoms, or alkoxy groups having from 1 to about 10 carbon atoms; f is zero or 1, but is always zero when R⁹ represents a hydrogen atom; t is zero or an integer of from 1 to 5; and w is zero or an integer of from 1 to 3.

Exemplary benzophenone compounds include, but are not limited to, 2-hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives. Exemplary benzophenone compounds also include 2,2′-dihydroxybenzophenone; 2,2′4,4′-tetrahydroxybenzophenone; 2,2′-dihydroxy-4,4′-dimethoxybenzophenone; 2,2′-dihydroxy-4,4′-diethoxybenzophenone; 2,2′-dihydroxy-4,4′-dipropoxybenzophenone; 2,2′-dihydroxy-4,4′-dibutoxybenzophenone; 2,2′-dihydroxy-4-methoxy-4′-ethoxybenzophenone; 2,2′-dihydroxy-4-methoxy-4′-propoxybenzophenone; 2,2′-dihydroxy-4-methoxy-4′-butoxybenzophenone; 2,2′-dihydroxy-4-ethoxy-4′-propoxybenzophenone; 2,2′-dihydroxy-4-ethoxy-4′-butoxybenzophenone; 2,3′-dihydroxy-4,4′-dimethoxybenzophenone; 2,3′-dihydroxy-4-methoxy-4′-butoxybenzophenone; 2-hydroxy-4,4′,5′-trimethoxybenzophenone; 2-hydroxy-4,4′,6′-tributoxybenzophenone; 2-hydroxy-4-butoxy-4′,5′-dimethoxybenzophenone; 2-hydroxy-4-ethoxy-2′,4′-dibutylbenzophenone; 2-hydroxy-4-propoxy-4′,6′-dichlorobenzophenone; 2-hydroxy-4-propoxy-4′,6′-dibromobenzophenone; 2,4-dihydroxybenzophenone; 2-hydroxy-4-methoxybenzophenone; 2-hydroxy-4-ethoxybenzophenone; 2-hydroxy-4-propoxybenzophenone; 2-hydroxy-4-butoxybenzophenone; 2-hydroxy-4-methoxy-4′-methylbenzophenone; 2-hydroxy-4-methoxy-4′-ethylbenzophenone; 2-hydroxy-4-methoxy-4′-propylbenzophenone; 2-hydroxy-4-methoxy-4′-butylbenzophenone; 2-hydroxy-4-methoxy-4′-tertiary butylbenzophenone; 2-hydroxy-4-methoxy-4′-chlorobenzophenone; 2-hydroxy-4-methoxy-2′-chlorobenzophenone; 2-hydroxy-4-methoxy-4′-bromobenzophenone; 2-hydroxy-4,4′-dimethoxybenzophenone; 2-hydroxy-4,4′-dimethoxy-3-methylbenzophenone; 2-hydroxy-4,4′-dimethoxy-2′-ethylbenzophenone; 2-hydroxy-4,4′,5′-trimethoxybenzophenone; 2-hydroxy-4-ethoxy-4′-methylbenzophenone; 2-hydroxy-4-ethoxy-4′-ethylbenzophenone; 2-hydroxy-4-ethoxy-4′-propylbenzophenone; 2-hydroxy-4-ethoxy-4′-butylbenzophenone; 2-hydroxy-4-ethoxy-4′-methoxybenzophenone; 2-hydroxy-4,4′-diethoxybenzophenone; 2-hydroxy-4-ethoxy-4′-propoxybenzophenone; 2-hydroxy-4-ethoxy-4′-butoxybenzophenone; 2-hydroxy-4-ethoxy-4′-chlorobenzophenone; and 2-hydroxy-4-ethoxy-4′-bromobenzophenone.

The composition may comprise ultra violet light absorber in an amount of 0.5 to 5 weight percent. Within this range, the ultra violet light absorber may be present in an amount greater than or equal to 0.6 weight percent, or, more specifically in an amount greater than or equal to 0.7 weight percent, or, even more specifically in an amount greater than or equal to 0.8 weight percent. Also within this range the ultra violet light absorber may be present in an amount less than or equal to 4.9 weight percent, or, more specifically, less than or equal to 4.8 weight percent, or, even more specifically, less than or equal to 4.7 weight percent. The weight percents are based on the total weight of the poly(arylene ether) and poly(alkenyl aromatic) resin.

A photobleachable dye is defined as an organic dye or pigment that bleaches upon exposure to light. In one embodiment the photobleachable dye comprises a purple anthrapyridone dye and/or a yellow quinophtalone dye with the following structural backbone: 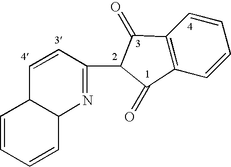
which may carry substituents, with the exception of such yellow quinophtalone dyes having a hydroxyl substituent in position 3′ of the structural backbone and/or a purple anthrapyridone dye. Quinophtalone dyes are known per se; a list of suitable quinophtalone dyes can be found in Helvetia Chimica Acta, vol. 52, fasc. 5 (1969) p. 1259-1273 enumerating some quinophtalone dyes of which the yellow ones without hydroxyl substituent in position 3′ may be used as a photobleachable dye.

Examples of photobleachable dyes include Color Index (denoted as C.I. hereinafter) Solvent Yellow 4, C.I. Solvent Yellow 16, C.I. Solvent Yellow 17, C.I. Solvent Yellow 28, C.I. Solvent Yellow 30, C.I. Solvent Yellow 33, C.I. Solvent Yellow 34, C.I. Solvent Yellow 44, C.I. Solvent Yellow 58, C.I. Solvent Yellow 77, C.I. Solvent Yellow 82, C.I. Solvent Orange 1, C.I. Solvent Orange 13, C.I. Solvent Red 52, C.I. Solvent Orange 45, C.I. Solvent Green 5, C.I. Pigment Yellow 13, C.I. Pigment Yellow 83, C.I. Pigment Yellow 97, C.I. Pigment Yellow 98, C.I. Pigment Yellow 108, C.I. Pigment Yellow 138, C.I. Pigment Orange 4. C.I. Solvent Yellow 33 is commercially available as Amaplast Yellow Y of the American Color & Chemical Co., and is a quinophtalone dye without any substituents on the quinophtalone backbone. C.I. Pigment Yellow 138 is commercially available as Paliotol Yellow K0961 HD from BASF. C.I. Solvent Red 52 is commercially available as Macrolex Red 5B from Messrs. Bayer Ag, and is believed to be a quinophtalone dye substituted with halogen atoms and one or more aromatic groups and without an hydroxyl group in position 3′.

The composition may comprise photobleachable dye in an amount of 0.01 to 1.0 weight percent. Within this range, the photobleachable dye may be present in an amount greater than or equal to 0.02 weight percent, or, more specifically in an amount greater than or equal to 0.03 weight percent. Also within this range the photobleachable dye may be present in an amount less than or equal to 0.9 weight percent, or, more specifically, less than or equal to 0.8 weight percent, or, even more specifically, less than or equal to 0.7 weight percent. The weight percents are based on the total weight of the poly(arylene ether) and poly(alkenyl aromatic) resin.

Anti-oxidants include phosphites and phosphonites. Exemplary phosphites include triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, tris(2,4-di-tert-butylphenyl) phosphite, and tris(nonylphenyl) phosphite.

The composition may comprise anti-oxidant in an amount of 0.05 to 1.5 weight percent. The weight percents are based on the total weight of the poly(arylene ether) and poly(alkenyl aromatic) resin.

Epoxy compounds are compounds which comprise an epoxide group. Suitable epoxy compounds are, for example, compounds of the formula: 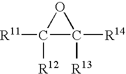
wherein R¹¹, R¹², R¹³ and R¹⁴ represent an organic group. Exemplary epoxy compounds include 3,4-epoxyhexahydrobenzyl-3,4-epoxy-hexahydrobenzoate and triglycidyl isocyanurate.

In one embodiment the epoxy compound comprises a cyclic aliphatic epoxy compound (or cycloaliphatic epoxies as they may also be termed). Examples include vinylcyclohexene dioxide, 3,4-epoxy-cyclohexylmethyl-3,4-epoxy cyclohexane carboxylate, 2-(3,4-epoxycyclohexyl)-5,5-spiro(3,4-epoxy)cyclohexane-m-dioxane, bis(3,4-epoxy-6-methylcyclohexylmethyl)adipate, bis(2,3-epoxy cyclopentyl)ether, dicyclopentadiene dioxide, 1,2-epoxy-6-(2,3-epoxy propoxy)hexahydro-4,7methanoindane, bis-3,4-epoxy-2,5-endomethylene cyclohexyl succinate, and bisepoxy dicyclopentyl succinate. An additional example is 3,4-epoxycyclohexyl-methyl-3,4-epoxy cyclohexane carboxylate, having the structure: 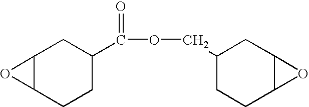
A commercial material having this structure is manufactured by Ciba-Geigy Corporation under the trade name ARALDITE CY179.

The composition may comprise epoxy compound in an amount of 0.5 to 5 weight percent. Within this range, the epoxy compound may be present in an amount greater than or equal to 0.6 weight percent, or, more specifically in an amount greater than or equal to 0.7 weight percent, or, even more specifically in an amount greater than or equal to 0.8 weight percent. Also within this range the epoxy compound may be present in an amount less than or equal to 4.9 weight percent, or, more specifically, less than or equal to 4.8 weight percent, or, even more specifically, less than or equal to 4.7 weight percent. The weight percents are based on the total weight of the poly(arylene ether) and poly(alkenyl aromatic) resin.

Additionally, the composition may optionally also contain various additives, such as fillers and reinforcing agents, such as, for example, silicates, TiO₂, fibers, glass fibers (including continuous and chopped fibers), carbon black, graphite, calcium carbonate, talc, mica and other additives such as, for example, mold release agents, lubricants, plasticizers, pigments, dyes, colorants, anti-static agents, blowing agents, and impact modifiers, among others.

In one embodiment the composition comprises poly(arylene ether), poly(alkenyl aromatic) resin, organic disphosphate, hindered amine light stabilizer, and ultra-violet light absorbing compound. The composition may optionally comprise a photobleachable dye, an anti-oxidant, an epoxy compound or a combination of two or more of the foregoing additives. The composition may have a UL 94 rating of V1 or better, or, more specifically, a rating of V0, at a thickness of 3 millimeters. The composition has a color shift less than 6, or, more specifically, less than 5, or, even more specifically, less than 4.5, when determined as described above.

In one embodiment a masterbatch comprises a resin, bisphenol A diphosphate, a hindered amine light stabilizer, and an ultra-violet light absorbing compound. The resin may be a poly(arylene ether), poly(alkenyl aromatic) resin or other resin that is suitable for use in a poly(arylene ether) composition. The masterbatch contains the organic disphosphate, hindered amine light stabilizer and ultra-violet light absorbing compound in an amount higher than found in the final composition. Exact amounts of each component in the masterbatch will depend upon the amounts desired in the final composition and on the available blending apparatus. The masterbatch may additionally comprise an antioxidant, photobleachable dye, epoxy compound or a combination of two or more of the foregoing. Use of the masterbatch when making the composition can facilitate dispersion of the components.

The composition may be made by blending the poly(arylene ether), the poly(alkenyl aromatic) resin, the organic disphosphate, hindered amine light stabilizer, ultra violet light absorbing compound, and other desired components with sufficient energy to form a blend. Blending may occur in an extruder, roll mill, dough mixer etc. The polymeric resin may be initially in the form of powder, strands or pellets and may be pre-compounded or dry blended with any of the other components of the composition.

The composition is further illustrated by the following non-limiting examples.

### EXAMPLES

The following examples employed the materials shown in Table 1.

TABLE 1

| Component | Description/Supplier |
|---|---|
| PPE I | A polyphenylene ether having an intrinsic |
| | viscosity of 0.31 dl/g as measured in |
| | chloroform at 25° C. |
| PPE II | A polyphenylene ether having an intrinsic |
| | viscosity of 0.46 dl/g as measured in |
| | chloroform at 25° C. |
| HIPS I | A commercially available rubber modified |
| | polystyrene with a melt flow index of 3 |
| | grams/10 minutes at 200° C. and 5 kilograms. |
| HIPS II | A commercially available high flow rubber |
| | modified polystyrene with a melt flow index of |
| | 7 grams/10 minutes at 200° C. and 5 kilograms. |
| HALS | A hindered amine light stabilizer commercially |
| | available from Ciba Specialty Chemicals under |
| | the tradename Tinuvin 770. |
| UV 1 | A hydroxybenzotriazole ultra violet light |
| | absorber commercially available from Cytec |
| | under the tradename Cyasorb UV5411. |
| UV 2 | A hydroxybenzotriazole ultra violet light |
| | absorber commercially available from Ciba |
| | Specialty Chemicals under the tradename |
| | Tinuvin 234. |
| UV 3 | A benzophenone ultra violet light absorber |
| | commercially available from Cytec under the |
| | tradename Cyasorb 531. |
| BPADP I | Bisphenol A tetraphenyl disphosphate |
| RDP I | Resorcinol diphosphate |
| 71B | Butylated triphenyl phosphate |
| TiO₂ | Titanium dioxide |
| Epoxy I | An epoxy compound commercially available |
| | from Dow Chemical under the tradename ERL- |
| | 4221. CAS No. 2386-87-0 |

### Examples 1-17

Compositions containing 31.3 wt % PPE I, 45.4 wt % HIPS 1 and 19 wt % of either RDP or BPADP, based on the combined weight of PPE I, HIPS I, additives and RDP or BPADP were made by melt blending. The composition further comprised a combined total of 4.3 wt %, based on the combined weight of PPE I, HIPS I, additives and RDP or BPADP, of additives such as pigments, photobleachable dye, and mold release agents. The UV light absorbing compound, TiO₂, and epoxy compound were varied as shown in Table 2 and the amounts are in weight percent based on the combined weight of PPE I, HIPS I, additives and BPADP or RDP. The PPE I and additives were dry blended and added at the feedthroat of the extruder with the UV I or UV II, HALS, TiO₂, epoxy compound and HIPS. The RDP or BPADP was added downstream. The compositions were injection molded into plaques (2 inches by 3 inches) and weathered in accordance with ASTM D4459 for 300 hours. Color shift (dE) was determined from the L*, a*, and b* values measured using a Gretag MacBeth spectrophotometer and according to ASTM 2244. The calibrated spectrophotometer measures the color using the reflectance mode. Results are shown in Table 2.

TABLE 2

| | | | | | Epoxy | Flame | |
|---|---|---|---|---|---|---|---|
| | UVA | UVA | TiO₂ | | compound | retardant | |
| Ex. | type | amount | amount | HALS | amount | type | dE |
| 1* | I | 1 | 4 | 1 | 0 | RDP | 9.99 |
| 2* | I | 3 | 4 | 1 | 2 | RDP | 4.02 |
| 3* | II | 1 | 4 | 1 | 2 | RDP | 8.24 |
| 4* | II | 3 | 4 | 1 | 0 | RDP | 7.48 |
| | | | | 1 | | | |
| 5 | I | 1 | 4 | 1 | 2 | BPADP | 4.99 |
| 6 | I | 3 | 4 | 1 | 0 | BPADP | 4.22 |
| 7 | II | 1 | 4 | 1 | 0 | BPADP | 7.56 |
| 8 | II | 3 | 4 | 1 | 2 | BPADP | 2.96 |
| 9* | I | 1 | 12 | 1 | 2 | RDP | 7.71 |
| 10* | I | 3 | 12 | 1 | 0 | RDP | 8.14 |
| 11* | II | 1 | 12 | 1 | 0 | RDP | 11.09 |
| 12* | II | 3 | 12 | 1 | 2 | RDP | 6.68 |
| | | | | 1 | | | |
| 13 | I | 1 | 12 | 1 | 0 | BPADP | 7.96 |
| 14 | I | 3 | 12 | 1 | 2 | BPADP | 3.8 |
| 15 | II | 1 | 12 | 1 | 2 | BPADP | 6.50 |
| 16 | II | 3 | 12 | 1 | 0 | BPADP | 6.61 |

*Comparative Examples

As can be seen from the foregoing examples containing the dE value is surprisingly lower when the composition contains an bisphenol A diphosphate as opposed to compositions containing resorcinol diphosphate. There also appears to be surprising improvement when the amount of UV absorbing compound is greater than 1 weight percent based on the total weight of PPE I, HIPS I, additives and RDP or BPADP and an epoxy compound is present.

### Examples 18-21

Compositions containing 31.3 wt % PPE I, 45.4 wt % HIPS 1 and 19 wt % of either RDP or BPADP, based on the combined weight of PPE I, HIPS I, additives, and RDP or BPADP were made by melt blending. The composition further comprised a combined total of 4.6 wt %, based on the combined weight of PPE I, HIPS I and RDP or BPADP, of additives such as pigments, photobleachable dye, anti-oxidant and mold release agents. The UV light absorbing compound, TiO₂, and hindered amine light stabilizer were varied as shown in Table 3 and the amounts are in weight percent based on the combined weight of PPE I, HIPS I, additives, and BPADP or RDP. The PPE and additives were dry blended and added at the feedthroat of the extruder with the UV light absorbing compound, HALS, TiO₂, and HIPS. The RDP or BPADP was added downstream. The compositions were injection molded into plaques (2 inches by 3 inches) and weathered in accordance with ASTM D4459 for 300 hours. Color shift (dE) was determined as described above. The calibrated spectrophotometer measures the color using the reflectance mode. Results are shown in Table 3.

TABLE 3

| | UV 1 | HALS I | TiO₂ | | | |
|---|---|---|---|---|---|---|
| Ex. | amount | amount | amount | RDP | BPADP | dE |
| 18* | 0.5 | 1.0 | 4.0 | X | — | 8.6 |
| 19 | 0.5 | 1.0 | 4.0 | — | X | 4.6 |
| 20* | 1.5 | 1.0 | 12.0 | X | — | 6.0 |
| 21 | 1.5 | 1.0 | 12.0 | — | X | 3.9 |

*Comparative Example

Examples 18-21 show that compositions containing bisphenol A diphosphate have a dE that is markedly less than the dE of comparable compositions containing resorcinol diphosphate which is surprising given the fact that both bisphenol A diphosphate and resorcinol diphosphate are aromatic diphosphates.

### Examples 22-25

Compositions containing 28 wt % PPE I, 49-51 wt % HIPS II and 18.7 wt % of either RDP or BPADP, based on the combined weight of PPE I, HIPS II, additives, and RDP or BPADP were made by melt blending. The composition further comprised a combined total of 6.8-8.8 wt %, based on the combined weight of PPE I, HIPS II and RDP or BPADP, of additives such as pigments, anti-oxidant and mold release agents. The PPE plus pigments and additives (including the UV light absorbing compound and HALS when present) were dry blended and added at the feedthroat of the extruder with the HIPS. The RDP or BPADP was added downstream. The compositions were injection molded into disks (10 cm in diameter by 3.2 mm thickness) and tested in accordance with ASTM D4459 for 300 hours. Color shift (dE) was determined as described above. Results are shown in Table 4.

TABLE 4

| | HIPS | UV 1 | HALS I | | | |
|---|---|---|---|---|---|---|
| Ex. | amount | amount | amount | RDP | BPADP | dE |
| 22* | 51 | 0 | 0 | X | — | 17.1 |
| 23* | 49 | 1.0 | 1.0 | X | — | 9.8 |
| 24 | 51 | 0 | 0 | — | X | 12.9 |
| 25 | 49 | 1.0 | 1.0 | — | X | 5.0 |

*Comparative Example

Examples 22-25 show that compositions containing bisphenol A diphosphate have a dE that is markedly less than the dE of comparable compositions containing resorcinol diphosphate which is surprising given the fact that both bisphenol A diphosphate and resorcinol diphosphate are aromatic diphosphates.

As used herein the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising poly(arylene ether), poly(alkenyl aromatic) resin, bis(hydroxy benzene) diphosphate, a hindered amine light stabilizer, and an ultra-violet light absorbing compound, wherein the composition has a color shift (dE), as determined by ASTM D2244 after weathering according ASTM D4459 for 300 hours, less than 6 and a flame retardance of V1 or better when determined by UL94 at a thickness of 3 millimeters.

2. The composition of claim 1 wherein the poly(arylene ether) comprises a product of a reaction of a poly(arylene ether) and a functionalizing agent.

3. The composition of claim 2 wherein the functionalizing agent comprises maleic anhydride.

4. The composition of claim 1 wherein the poly(arylene ether) is present in an amount of 20 to 80 weight percent based on the total weight of the poly(arylene ether) and poly(alkenyl aromatic) resin.

5. The composition of claim 1 wherein the poly(alkenyl aromatic) resin comprises a rubber modified poly(alkenyl aromatic) resin.

6. The composition of claim 1 wherein the poly(alkenyl aromatic) resin is present in an amount of 20 to 80 weight percent based on the total weight of the poly(arylene ether) and poly(alkenyl aromatic) resin.

7. The composition of claim 1 wherein the bis(hydroxy benzene) diphosphate has the formula: 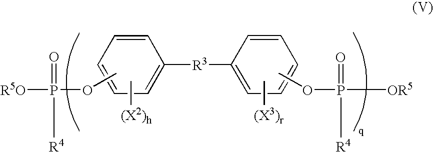
in which R³ is an alkyl having 1 to 5 carbons, each occurrence of R⁵ is, independently, an alkyl group having 1 to 8 carbons or an aryl group having 6 to 12 carbons; each occurrence of R⁴ is an alkyl, aryl, alkoxy or aryloxy having 1 to 12 carbons; X² and X³ are independently halogen or methyl; h and r are 0 or integers from 1 to 4, and q is from 1 to 10.

8. The composition of claim 1 wherein the bis(hydroxy benzene) diphosphate comprises bisphenol A diphosphate.

9. The composition of claim 1 wherein the bis(hydroxy benzene) diphosphate is present in an amount of 5 to 30 weight percent based on the total weight of the poly(arylene ether) and poly(alkenyl aromatic) resin.

10. The composition of claim 1 wherein the hindered amine light stabilizer is present in an amount of 0.5 to 3.0 weight percent based on the total weight of the poly(arylene ether) and poly(alkenyl aromatic) resin.

12. The composition of claim 1 wherein the ultra-violet light absorbing compound comprises a benzotriazole, a benzophenone or a combination thereof.

13. The composition of claim 1 wherein the ultra violet light absorber is present in an amount of 0.5 to 5 weight percent based on the total weight of the poly(arylene ether) and poly(alkenyl aromatic) resin.

14. The composition of claim 1 further comprising a photobleachable dye.

15. The composition of claim 14 wherein the photobleachable dye is present in an amount of 0.01 to 1.0 weight percent based on the total weight of the poly(arylene ether) and poly(alkenyl aromatic) resin.

16. The composition of claim 1 further comprising an anti-oxidant.

17. The composition of claim 1 further comprising an epoxy compound.

18. The composition of claim 17 wherein the epoxy compound is present in an amount of 0.5 to 5 weight percent based on the total weight of the poly(arylene ether) and poly(alkenyl aromatic) resin.

19. The composition of claim 1 wherein the composition further comprises a filler, reinforcing agent, carbon black, graphite, calcium carbonate, talc, mica, mold release agent, lubricant, plasticizers, pigment, dye, colorant, anti-static agent, blowing agent or a combination of two or more of the foregoing.

20. A composition comprising poly(arylene ether), poly(alkenyl aromatic) resin, bis(hydroxy benzene) diphosphate, a hindered amine light stabilizer, and an ultra-violet light absorbing compound, wherein the hindered amine light stabilizer and ultra-violet light absorbing compound are present in a combined amount of 2.5 to 5 weight percent based on the total weight of the poly(arylene ether) and poly(alkenyl aromatic) resin and the composition has a color shift less than 6 as determined by ASTM D2244 after weathering according ASTM D4459 for 300 hours and a flame retardance of V1 or better when determined by UL94 at a thickness of 3 millimeters.

21. A composition comprising poly(arylene ether), poly(alkenyl aromatic) resin, bis(hydroxy benzene) diphosphate, hindered amine light stabilizer, ultra-violet light absorbing compound, and an epoxy compound.

22. The composition of claim 21 wherein the composition has a color shift (dE) of less than or equal to 5 as determined by ASTM D2244 after weathering according ASTM D4459 for 300 hours.

23. The composition of claim 21 wherein the composition has a flame retardance of V1 or better according to UL 94.

24. A composition comprising poly(arylene ether), poly(alkenyl aromatic) resin, bis(hydroxy benzene) diphosphate, hindered amine light stabilizer, photobleachable dye, ultra-violet light absorbing compound, anti-oxidant, and an epoxy compound.

25. The composition of claim 24 wherein the composition has a color shift (dE) of less than or equal to 5 as determined by ASTM D2244 after weathering according ASTM D4459 for 300 hours.

26. The composition of claim 24 wherein the composition has a flame retardance of V1 or better according to UL 94.

27. A masterbatch comprising a resin, bisphenol A diphosphate, a hindered amine light stabilizer, and an ultra-violet light absorbing compound
